(19) United States
(12) Patent Application Publication
(10) Pub. No.: US 2026/0171576 A1
(43) Pub. Date: Jun. 18, 2026

(54) BATTERY ASSEMBLY AND METHOD FOR MANUFACTURING THE SAME

(71) Applicant: SK On Co., Ltd., Seoul (KR)

(72) Inventor: Dong Jun LIM, Daejeon (KR)

(21) Appl. No.: 19/383,755

(22) Filed: Nov. 10, 2025

(30) Foreign Application Priority Data
Dec. 18, 2024 (KR) 10-2024-0189851

(51) Int. Cl. H01M 50/262; H01M 10/04; H01M 50/242

(52) U.S. Cl. CPC H01M 50/262; H01M 10/04; H01M 50/242

(57) ABSTRACT

The present disclosure relates to a battery assembly and a method of manufacturing the same. The battery assembly includes a case comprising a lower plate, a side plate connected to the lower plate to form a receiving space together with the lower plate, and an upper plate coupled to the side plate to seal the receiving space; a plurality of battery cells coupled to the lower plate and accommodated in the receiving space; and an adhesive layer disposed between the lower plate and the plurality of battery cells and adhering the lower plate and one surface of each of the plurality of battery cells, wherein the adhesive layer Includes a reinforcement member at least a portion of which is prevented from being deformed in shape by a load applied from the plurality of battery cells.

### CROSS-REFERENCE TO RELATED PATENT APPLICATION

The present application claims priority under 35 U.S.C. § 119(a) to Korean patent application number 10-2024-0189851 filed on Dec. 18, 2024, in the Korean Intellectual Property Office, the entire disclosure of which is incorporated by reference herein.

### BACKGROUND OF THE INVENTION

### 1. Field

The present disclosure relates to a battery assembly and a method of manufacturing the same, and more particularly, to a battery assembly and a method of manufacturing the same in which an adhesive layer adhering a lower plate of the battery assembly and a battery cell can be prevented from being reduced in thickness by a load of the battery cell.

### 2. Description of the Related Art

A battery cell includes an electrode assembly in which a positive electrode plate coated with a positive electrode active material and a negative electrode plate coated with a negative electrode active material are disposed with a separator interposed therebetween, and an exterior material sealingly accommodating the electrode assembly together with an electrolyte.

In recent years, as the necessity for large-capacity structures has increased, along with use as an energy storage source, demand has been increasing for battery assemblies such as a battery module in which a plurality of battery cells electrically connected in series and/or in parallel are accommodated, and a battery management system (BMS).

Such a battery assembly generally includes a case made of a metal material to protect the plurality of battery cells from external impact or to accommodate and store the plurality of battery cells, and the plurality of battery cells accommodated in the case are coupled to a lower plate of the case through an adhesive layer.

Generally, the adhesive layer is formed of an adhesive member having a predetermined thickness capable of adhering a lower plate of a case and one surface of a battery cell, and the adhesive layer disposed between the battery cell and the lower plate functions as a parasitic capacitor.

Meanwhile, parasitic capacitance increases as the thickness of the parasitic capacitor decreases. Accordingly, when the thickness of the adhesive layer decreases due to a load of the battery cell, the parasitic capacitance increases, thereby increasing an amount of current leaked from the battery cell.

As such, when the amount of current leaked from the battery cell increases, there arises a problem in that utilization efficiency of the battery cell as a power source decreases.

Therefore, it is necessary to develop a battery assembly including an adhesive layer capable of being prevented from being reduced in thickness by a load of the battery cell, and a method of manufacturing the same.

### SUMMARY OF THE INVENTION

An object of the present disclosure is to provide a battery assembly capable of being prevented from an increase in parasitic capacitance of an adhesive layer disposed between a plurality of battery cells and a lower plate.

Another object of the present disclosure is to provide a method of manufacturing a battery assembly capable of being prevented from an increase in parasitic capacitance of an adhesive layer disposed between a plurality of battery cells and a lower plate.

The battery assembly and the method of manufacturing the same according to the present disclosure can be widely used in the field of green technology utilizing batteries such as electric vehicles. In addition, the battery assembly manufactured through the battery assembly and the method of manufacturing the same of the present disclosure can be used in eco-friendly electric vehicles, hybrid vehicles, and the like for preventing climate change by suppressing air pollution and greenhouse gas emissions.

As a technical means for solving the above-described technical problem, a battery assembly according to an embodiment of the present disclosure includes: a case including a lower plate, a side plate connected to the lower plate to form a receiving space together with the lower plate, and an upper plate coupled to the side plate to seal the receiving space; a plurality of battery cells coupled to the lower plate and accommodated in the receiving space; and an adhesive layer disposed between the lower plate and the plurality of battery cells and adhering the lower plate and one surface of each of the plurality of battery cells, wherein the adhesive layer may include a reinforcement member preventing the adhesive layer from being deformed in shape by a load applied from the plurality of battery cells.

In addition, the plurality of battery cells are stacked along a first direction parallel to the lower plate, and wherein the reinforcement member is formed such that at least a portion thereof is disposed between the one surface of each of the plurality of battery cells and the lower plate.

In addition, the reinforcement member may include a first reinforcement portion formed to extend in a longitudinal direction, and the first reinforcement portion may be disposed such that one end thereof is located between the battery cell positioned at one end in the first direction among the plurality of battery cells and the lower plate, and the other end thereof is located between the battery cell positioned at the opposite end in the first direction among the plurality of battery cells and the lower plate.

In addition, the reinforcement member includes a first reinforcement portion formed to extend in a longitudinal direction, and wherein the first reinforcement portion is disposed such that one end thereof is located between the battery cell positioned at one end in the first direction among the plurality of battery cells and the lower plate, and the other end thereof is located between the battery cell positioned at the opposite end in the first direction among the plurality of battery cells and the lower plate.

In addition, at least a portion of the first reinforcement portion may be disposed to face a first portion of the one surface of each of the plurality of battery cells, and the first portion may be a portion located between one end and the other end in a direction perpendicular to the first direction of the one surface of each of the plurality of battery cells.

In addition, the reinforcement member may include a plurality of second reinforcement portions formed to extend in a longitudinal direction, some of the plurality of second reinforcement portions may be disposed between one end of the one surface of each of the plurality of battery cells in a direction perpendicular to the first direction and the first reinforcement portion, and the remainder may be disposed between the other end of the one surface of each of the plurality of battery cells in the direction perpendicular to the first direction and the first reinforcement portion.

In addition, some of the plurality of second reinforcement portions may be disposed between one end of the one surface of each of the plurality of battery cells in a direction perpendicular to the first direction and the first portion, and the remainder may be disposed between the other end of the one surface of each of the plurality of battery cells in the direction perpendicular to the first direction and the first portion.

In addition, the adhesive layer may include an adhesive member disposed in a space between the plurality of battery cells and the lower plate, except for a space in which the reinforcement member is disposed.

In addition, the reinforcement member may be formed of silicone.

As a technical means for solving the above-described technical problem, a method of manufacturing a battery assembly according to an embodiment of the present disclosure comprises: a preparation step of preparing a case including a lower plate, a side plate connected to the lower plate to form a receiving space together with the lower plate, and an upper plate coupled to the side plate to seal the receiving space; an adhesion step of adhering the plurality of battery cells and the lower plate through an adhesive layer disposed between the plurality of battery cells and the lower plate; a receiving step of accommodating components of the battery assembly in the receiving space; and a sealing step of coupling the upper plate to the side plate to seal the receiving space, wherein the adhesive layer may include a reinforcement member preventing the adhesive layer from being deformed in shape by a load applied from the plurality of battery cells.

In addition, the reinforcement member may be formed such that at least a portion thereof is disposed between the one surface of each of the plurality of battery cells and the lower plate.

In addition, the plurality of battery cells may be stacked along a first direction parallel to the lower plate, the reinforcement member may include a first reinforcement portion formed to extend in a longitudinal direction, and the first reinforcement portion may be disposed such that one end thereof is located between the battery cell positioned at one end in the first direction among the plurality of battery cells and the lower plate, and the other end thereof is located between the battery cell positioned at the opposite end in the first direction among the plurality of battery cells and the lower plate.

In addition, at least a portion of the first reinforcement portion may be disposed to face a first portion of the one surface of each of the plurality of battery cells, and the first portion may be a portion located between one end and the other end in a direction perpendicular to the first direction of the one surface of each of the plurality of battery cells.

In addition, the reinforcement member may include a plurality of second reinforcement portions formed to extend in a longitudinal direction, some of the plurality of second reinforcement portions may be disposed between one end of the one surface of each of the plurality of battery cells in a direction perpendicular to the first direction and the first reinforcement portion, and the remainder may be disposed between the other end of the one surface of each of the plurality of battery cells in the direction perpendicular to the first direction and the first reinforcement portion.

In addition, some of the plurality of second reinforcement portions may be disposed between one end of the one surface of each of the plurality of battery cells in a direction perpendicular to the first direction and the first portion, and the remainder may be disposed between the other end of the one surface of each of the plurality of battery cells in the direction perpendicular to the first direction and the first portion.

In addition, the adhesive layer may include an adhesive member disposed in a space between the plurality of battery cells and the lower plate, except for a space in which the reinforcement member is disposed.

Specific details of other embodiments for achieving the objects are included in the description of the invention and drawings.

According to the means for solving the problems of the present disclosure described above, the battery assembly according to the present disclosure provides an effect of preventing an increase in parasitic capacitance of the adhesive layer, since the adhesive layer includes a reinforcement member and is thereby prevented from being reduced in thickness by a load of the battery cell.

In addition, the method of manufacturing a battery assembly according to the present disclosure provides an effect in that a battery assembly including an adhesive layer capable of being prevented from an increase in parasitic capacitance by including the reinforcement member can be manufactured.

### BRIEF DESCRIPTION OF THE DRAWINGS

FIG. 1 is an exploded perspective view showing a battery assembly according to an embodiment of the present disclosure.

FIG. 2 is a view showing a receiving space formed by a lower plate and a side plate.

FIG. 3 is a view showing an adhesive layer.

FIG. 4 is a view showing an adhesive layer whose thickness is reduced by a load of a battery cell.

FIG. 5 is a view showing an adhesive layer whose thickness is not reduced by a load of a battery cell by including a reinforcement member.

FIG. 6 is a view showing a position at which a reinforcement member is disposed between a plurality of battery cells and a lower plate.

FIG. 7 is a view showing a position at which a first reinforcement portion formed to extend in a longitudinal direction is disposed between a plurality of battery cells and a lower plate.

FIG. 8 is a view showing a state in which the first reinforcement portion of FIG. 7 is disposed to face a middle portion of one surface of each of the battery cells.

FIG. 9 is a view showing a position at which a plurality of second reinforcement portions formed to extend in a longitudinal direction are disposed between a plurality of battery cells and a lower plate.

FIG. 10 is a view showing a state in which the second reinforcement portions of FIG. 9 are disposed between an end and a middle portion of one surface of each of the battery cells.

FIG. 11 is a graph showing parasitic capacitance and thermal resistance of an adhesive layer according to the height of the adhesive layer.

FIG. 12 is a flowchart showing a method of manufacturing a battery assembly according to an embodiment of the present disclosure.

### DETAILED DESCRIPTION

Hereinafter, referring to the accompanying drawings, embodiments of the present disclosure are described in detail so that those skilled in the art to which the present disclosure pertains can easily practice them. However, the present disclosure may be implemented in a number of different forms and is not limited to the embodiments described herein. Further, in order to clearly explain the present disclosure in the drawings, parts that are not related to the explanation are omitted, and similar parts are given similar reference numerals throughout the specification.

Throughout the specification, when it is mentioned that a part is "connected" to another part, it includes not only the case where they are "directly connected," but also the case where they are "electrically connected" with another element in between.

Throughout the specification, when it is mentioned that an element is "on" another element, this includes not only the case where the element is in contact with the other element, but also the case where there is another element between the two elements.

Throughout the specification, when it is mentioned that a part "includes" or "comprises" a component, this does not mean that it excludes other components, but rather that it may include other components, unless otherwise specifically stated. The terms such as "about" and "substantially", which indicate degrees, as used throughout the specification, are used in a meaning that is at or near a numerical value when manufacturing and material tolerances inherent in the meanings stated are given, and are used to prevent unscrupulous infringers from unfairly exploiting the disclosure, which states precise or absolute numbers to aid understanding of the present disclosure. The terms "step of doing ~" or "step of ~" as used throughout the specification do not mean "step for ~".

Hereinafter, with reference to the accompanying drawings and the description below, preferred embodiments of the present disclosure are described in detail. However, the present disclosure is not limited to the embodiments described here, but may be embodied in other forms. Throughout the specification, the same reference numerals represent the same components.

Hereinafter, the configuration of a battery assembly according to an embodiment of the present disclosure will be described.

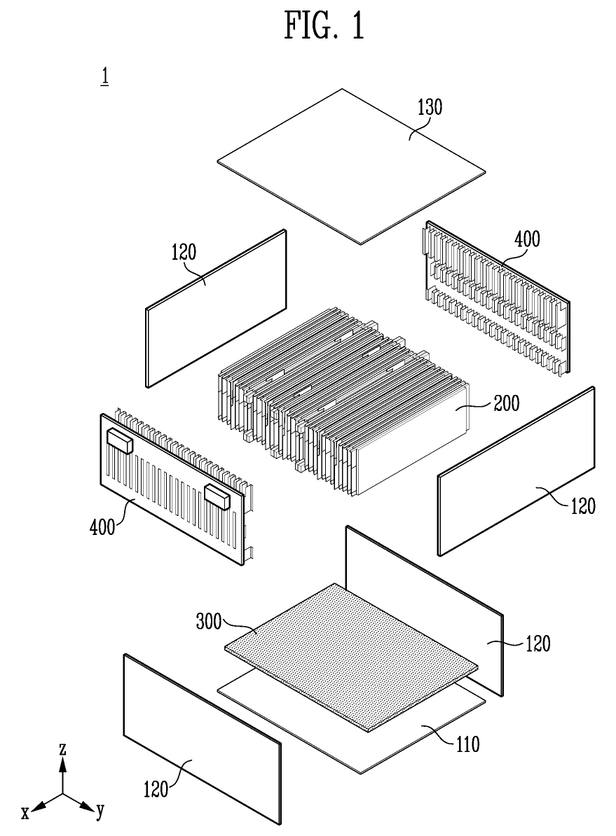

FIG. 1 is an exploded perspective view showing a battery assembly according to an embodiment of the present disclosure.

Referring to FIG. 1, a battery assembly 1 includes a case 100, battery cells 200, an adhesive layer 300, and a busbar assembly 400.

First, the case 100 will be described.

As shown in FIG. 1, the case 100 includes a lower plate 110, a side plate 120 connected to the lower plate 110 to form a receiving space S together with the lower plate 110, and an upper plate 130 coupled to the side plate 120 to seal the receiving space S.

The lower plate 110 may form a lower portion of the case 100 constituting an exterior of the battery assembly 1, and may be formed as a plate having a plate shape.

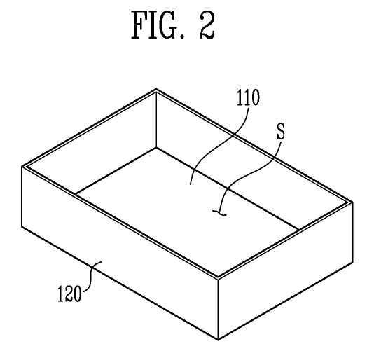

FIG. 2 is a view showing a receiving space formed by a lower plate and a side plate.

The side plate 120 may form a side portion of the case 100 constituting an exterior of the battery assembly 1, and as shown in FIG. 2, may be connected to the lower plate 110 to form a receiving space S together with the lower plate 110.

The side plate 120 may be formed separately from the lower plate 110 and coupled to the lower plate 110, but may also be formed integrally with the lower plate 110 to be connected to the lower plate 110.

The upper plate 130 may form an upper portion of the case 100 constituting an exterior of the battery assembly 1, and may be formed as a plate having a plate shape.

The upper plate 130 may be coupled to the side plate 120 to seal the receiving space S.

Next, the battery cell 200 will be described.

The battery cell 200 may include an electrode assembly and an exterior material accommodating the electrode assembly.

The electrode assembly is an assembly of electrode plates coated with an electrode active material and a separator, and may be configured such that one or more positive electrode plates and one or more negative electrode plates are disposed with a separator interposed therebetween.

The positive electrode plate of the electrode assembly is provided with a positive electrode tab, and one or more positive electrode tabs may be connected to a positive electrode lead. The positive electrode lead has one end connected to the positive electrode tab and the other end exposed to the outside of the battery cell, and the exposed portion may function as a positive electrode terminal of the secondary battery.

The negative electrode plate of the electrode assembly is provided with a negative electrode tab, and one or more negative electrode tabs may be connected to a negative electrode lead. The negative electrode lead has one end connected to the negative electrode tab and the other end exposed to the outside of the battery cell, and the exposed portion may function as a negative electrode terminal of the secondary battery.

The exterior material may be formed of a pouch or the like, and depending on the type of the exterior material, the battery cell 200 may be formed as a pouch-type secondary battery, a cylindrical secondary battery, a prismatic secondary battery, or the like, without being limited thereto.

As shown in FIG. 1, the battery cells 200 may be stacked along a predetermined first direction (y direction) parallel to the lower plate 110, coupled to the lower plate 110, and accommodated in the receiving space S.

Next, the adhesive layer 300 will be described.

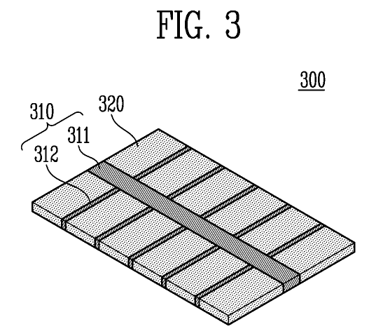

FIG. 3 is a view showing an adhesive layer.

Referring to FIG. 3, the adhesive layer 300 includes a reinforcement member 310 and an adhesive member 320, is disposed between the lower plate 110 and the plurality of battery cells 200, and can adhere the lower plate 110 and one surface of each of the battery cells 200.

That is, the adhesive layer 300 includes the reinforcement member 310 preventing the adhesive layer 300 from being deformed in shape by a load applied from the plurality of battery cells.

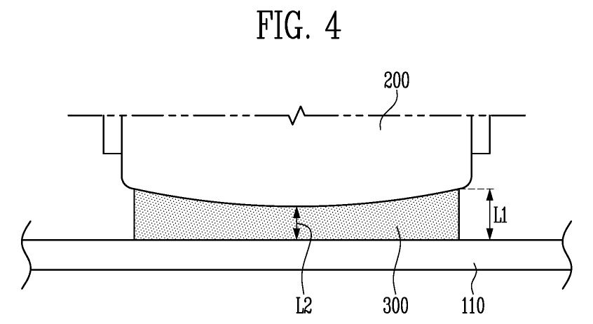

FIG. 4 is a view showing an adhesive layer whose thickness is reduced by a load of a battery cell.

As shown in FIG. 4, when the adhesive layer 300 disposed between the battery cell 200 and the lower plate 110 does not include the reinforcement member 310, at least a portion of the adhesive layer 300 having a thickness, which is a length in a direction perpendicular to the lower plate 110, of a first length L1 may be reduced to a second length L2 by a load of the battery cell 200. In this case, the second length L2 may be smaller than the first length L1.

In particular, as the battery cell 200 generally repeats charging and discharging, a middle portion of one surface 210 of the battery cell 200 facing the adhesive layer 300 bulges outward, so that the thickness of the portion of the adhesive layer 300 in contact with the middle portion of the one surface 210 of the battery cell 200 may be reduced the most.

Meanwhile, since the parasitic capacitance of the adhesive layer 300 functioning as a parasitic capacitor is proportional to the dielectric constant and the cross-sectional area of the adhesive layer 300 parallel to the lower plate 110, and inversely proportional to the thickness of the adhesive layer 300, when the thickness of the adhesive layer 300 decreases due to a load of the battery cell 200, the parasitic capacitance of the adhesive layer 300 increases.

As such, when the parasitic capacitance increases, the amount of current leaked from the battery cell 200 increases, and thus the utilization efficiency of the battery cell 200 as a power source may be reduced.

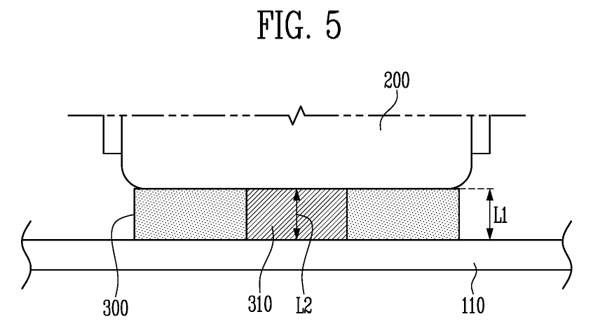

FIG. 5 is a view showing an adhesive layer whose thickness is not reduced by a load of a battery cell by including a reinforcement member.

In contrast, as shown in FIG. 5, when the adhesive layer 300 disposed between the battery cell 200 and the lower plate 110 includes the reinforcement member 310, a portion of the adhesive layer 300 in which the reinforcement member 310 is located is not deformed in shape, and thus the portion of the adhesive layer 300 in which the reinforcement member 310 is located does not have its thickness reduced by a load of the battery cell 200.

That is, even when the adhesive layer 300 having a thickness of a first length L1 is disposed between the battery cell 200 and the lower plate 110, the thickness may be maintained at the first length L1.

In particular, as described above, the thickness of the portion of the adhesive layer 300 in contact with the middle portion of one surface 210 of the battery cell 200 is generally reduced the most. When the reinforcement member 310 is disposed between the middle portion of one surface 210 of the battery cell 200 and the lower plate 110, it is possible to effectively prevent the thickness of the adhesive layer 300 from being reduced by a load of the battery cell 200.

Accordingly, it is possible to effectively prevent an increase in the parasitic capacitance of the adhesive layer 300, thereby effectively preventing an increase in the amount of current leaked from the battery cell 200, and also preventing a decrease in the utilization efficiency of the battery cell 200 as a power source.

The reinforcement member 310 performing such a function may have rigidity capable of being prevented from being deformed in shape by a load of the battery cell 200, and may be formed of a material having the smallest possible dielectric constant.

For example, the reinforcement member 310 may be formed of silicone, but the configuration of the reinforcement member 310 is not limited thereto.

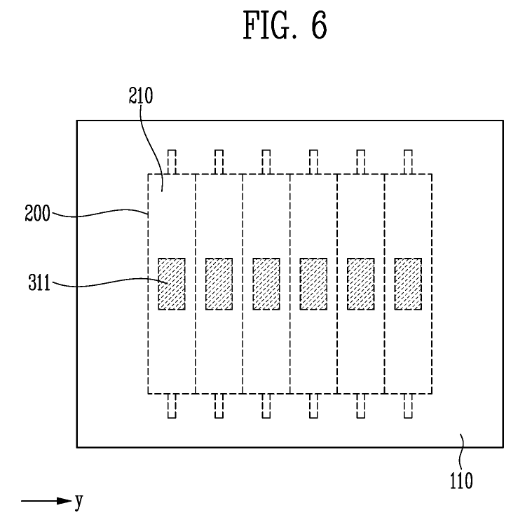

FIG. 6 is a view showing a position at which a reinforcement member is disposed between a plurality of battery cells and a lower plate.

As shown in FIG. 6, the reinforcement member 310 may be formed such that at least a portion thereof is disposed between the one surface 210 of each of the battery cells 200 and the lower plate 110 so as to prevent the thickness of the adhesive layer 300 from being reduced.

Meanwhile, as shown in FIG. 3, the reinforcement member 310 may include a first reinforcement portion 311 and a second reinforcement portion 312, and positions at which the first reinforcement portion 311 and the second reinforcement portion 312 are disposed in the adhesive layer 300 may be determined so as to effectively prevent the thickness of the adhesive layer 300 from being reduced.

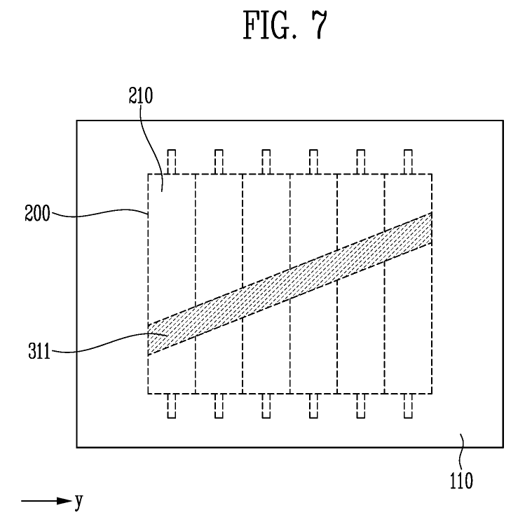

FIG. 7 is a view showing a position at which a first reinforcement portion formed to extend in a longitudinal direction is disposed between a plurality of battery cells and a lower plate.

For example, as shown in FIG. 7, the reinforcement member 310 may include a first reinforcement portion 311 formed to extend in a longitudinal direction.

The first reinforcement portion 311 may be disposed such that one end thereof is located between the battery cell 200 positioned at an end in the first direction (y direction) among the plurality of battery cells 200 and the lower plate 110, and the other end thereof is located between the battery cell 200 positioned at the opposite end in the first direction (y direction) among the plurality of battery cells 200 and the lower plate 110.

When the first reinforcement portion 311 is disposed in this manner, since one surface 210 of each of the battery cells 200 is supported by the first reinforcement portion 311, the thickness of the adhesive layer 300 may be effectively prevented from being reduced by a load of each of the battery cells 200.

In this case, a position at which the first reinforcement portion 311 is disposed in the adhesive layer 300 may be determined so as to more effectively prevent the thickness of the adhesive layer 300 from being reduced.

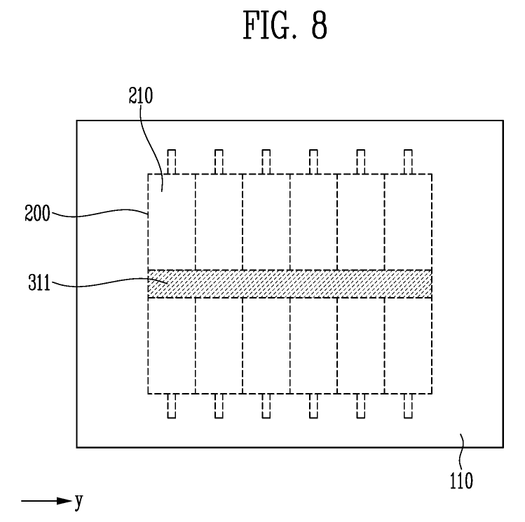

FIG. 8 is a view showing a state in which the first reinforcement portion of FIG. 7 is disposed to face a middle portion of one surface of each of the battery cells.

Specifically, as shown in FIG. 8, the first reinforcement portion 311 may be disposed such that at least a portion thereof faces a first portion of one surface 210 of each of the battery cells 200, and the first portion may be a portion located between one end and the other end in a direction perpendicular to the first direction (y direction) of the one surface 210 of each of the battery cells 200 (hereinafter referred to as the first portion).

That is, the first reinforcement portion 311 may be disposed to face the middle of one surface 210 of each of the battery cells 200.

As described above, since the thickness of the portion of the adhesive layer 300 in contact with the middle portion of one surface 210 of the battery cell 200 is generally reduced the most, when the first reinforcement portion 311 is disposed at a position facing the middle of one surface 210 of each of the battery cells 200, the reduction in the thickness of the adhesive layer 300 can be more effectively prevented.

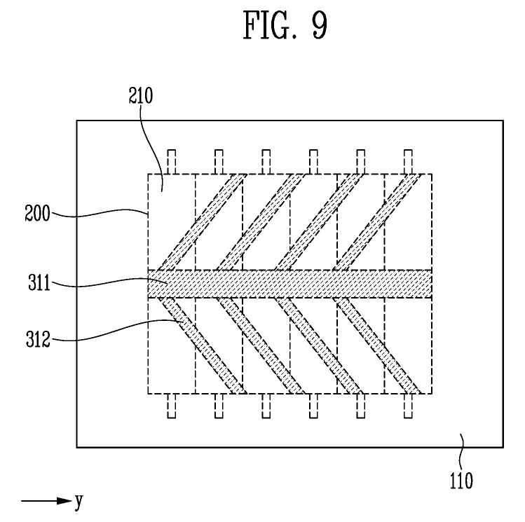

FIG. 9 is a view showing a position at which a plurality of second reinforcement portions formed to extend in a longitudinal direction are disposed between a plurality of battery cells and a lower plate.

By way of another example, as shown in FIG. 9, the reinforcement member 310 may include a plurality of second reinforcement portions 312 formed to extend in a longitudinal direction.

The first reinforcement portion 311 may be disposed to face the middle of one surface 210 of each of the battery cells 200, some of the plurality of second reinforcement portions 312 may be disposed between one end of one surface 210 of each of the battery cells 200 in a direction perpendicular to the first direction (y direction) and the first reinforcement portion 311, and the remainder may be disposed between the other end of one surface 210 of each of the battery cells 200 in the direction perpendicular to the first direction (y direction) and the first reinforcement portion 311.

When the second reinforcement portions 312 are disposed in this manner, portions of one surface 210 of each of the battery cells 200 located farther from the middle of the one surface 210 are also supported by the second reinforcement portions 312, so that the thickness of the adhesive layer 300 may be effectively prevented from being reduced by a load of each of the battery cells 200.

In this case, positions at which the second reinforcement portions 312 are disposed in the adhesive layer 300 may be determined so as to more effectively prevent the thickness of the adhesive layer 300 from being reduced.

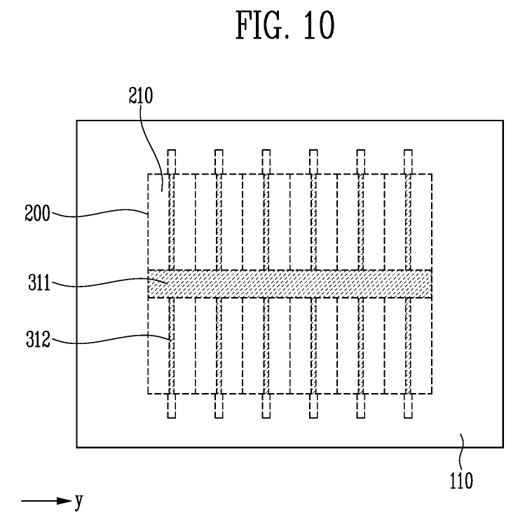

FIG. 10 is a view showing a state in which the second reinforcement portions of FIG. 9 are disposed between an end and a middle portion of one surface of each of the battery cells.

Specifically, as shown in FIG. 10, some of the plurality of second reinforcement portions 312 may be disposed between one end of one surface 210 of each of the battery cells 200 in a direction perpendicular to the first direction (y direction) and the first portion of the one surface 210 of the battery cell 200, and the remainder may be disposed between the other end of the one surface 210 of each of the battery cells 200 in the direction perpendicular to the first direction (y direction) and the first portion.

That is, the second reinforcement portions 312 may be formed to extend in a direction from one end or the other end of one surface 210 of each of the battery cells 200 toward the middle of the one surface 210.

As described above, since the middle portion of one surface 210 of the battery cell 200 facing the adhesive layer 300 generally bulges outward, portions extending from the middle portion of the one surface 210 toward both ends of the one surface 210 also expand. Therefore, when the second reinforcement portions 312 are formed to extend in a direction from one end or the other end of one surface 210 of each of the battery cells 200 toward the middle of the one surface 210, the reduction in the thickness of the adhesive layer 300 can be more effectively prevented.

The adhesive layer 300 may include an adhesive member 320 disposed in a space between the plurality of battery cells 200 and the lower plate 110, except for a space in which the reinforcement member 310 is disposed.

The adhesive member 320 may be formed of a material having adhesiveness and may perform a function of adhering the battery cell 200 and the lower plate 110 to each other.

Meanwhile, the adhesive layer 300 may be formed to have a predetermined thickness range so as to be configured not to degrade the heat dissipation performance of the battery cell 200 while preventing an increase in parasitic capacitance.

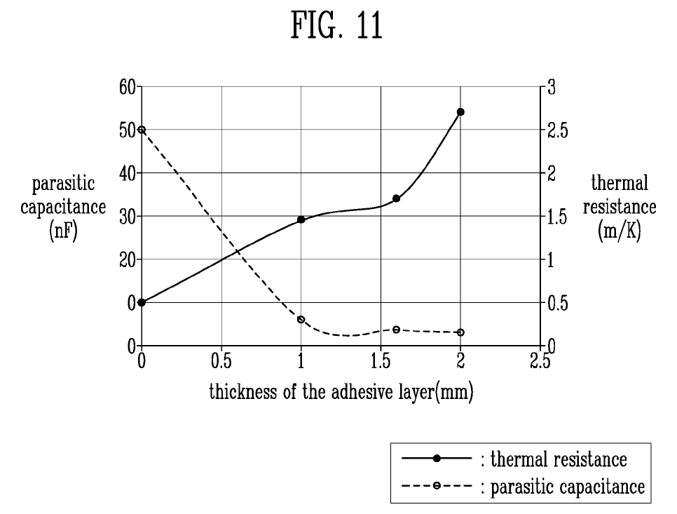

FIG. 11 is a graph showing parasitic capacitance and thermal resistance of an adhesive layer according to the height of the adhesive layer.

Referring to FIG. 11, the parasitic capacitance of the adhesive layer 300, at which leakage current from the battery cell 200 can be effectively prevented from occurring and degrading the performance of the battery cell 200, must be equal to or less than a preset first value, and when the preset first value is 10 nF, the adhesive layer 300 must have a thickness of about 1 mm or more.

In addition, the thermal resistance of the adhesive layer 300, at which degradation of the heat dissipation performance of the battery cell 200 can be effectively prevented, must be equal to or less than a preset second value, and when the preset second value is 1.75 m/K, the adhesive layer 300 must have a thickness of about 1.6 mm or less.

Therefore, when the preset first value is 10 nF and the preset second value is 1.75 m/K, in order to effectively prevent degradation of the performance of the battery cell 200 while also effectively preventing degradation of the heat dissipation performance of the battery cell 200, the thickness of the adhesive layer 300 must be about 1 mm or more and about 1.6 mm or less.

However, as the preset first value and the preset second value vary, the range of the thickness of the adhesive layer 300 for effectively preventing degradation of the performance of the battery cell 200 while also effectively preventing degradation of the heat dissipation performance of the battery cell 200 may change.

Next, the busbar assembly 400 will be described.

Referring to FIG. 1, the busbar assembly 400 may include at least one busbar configured to electrically interconnect the plurality of battery cells 200 and a busbar frame configured to mount the busbar on an outer side.

As shown in FIG. 1, such a busbar assembly 400 may be accommodated in the receiving space S while being disposed to face each other with the plurality of stacked battery cells 200 interposed therebetween so as to be electrically connected to the plurality of battery cells 200.

Hereinafter, the operation and effects of the battery assembly according to an embodiment of the present disclosure will be described.

The plurality of battery cells 200, the busbar assembly 400, and components of the battery assembly 1 are disposed in the receiving space S formed by the lower plate 110 and the side plate 120 of the battery assembly 1.

Next, the upper plate 130 may be coupled to the side plate 120 so as to seal the receiving space S.

Meanwhile, the plurality of battery cells 200 may be coupled to the lower plate 110 through the adhesive layer 300 including the reinforcement member 310 and the adhesive member 320.

In this case, the reinforcement member 310 of the adhesive layer 300 may include the first reinforcement portion 311 and may further include the second reinforcement portion 312.

By the reinforcement member 310, the adhesive layer 300 can be prevented from having its thickness reduced by a load of the battery cell 200, and accordingly, an increase in parasitic capacitance of the adhesive layer 300 can be prevented.

As such, the battery assembly according to the present disclosure provides an effect of preventing an increase in parasitic capacitance of the adhesive layer, since the adhesive layer includes the reinforcement member and is thereby prevented from being reduced in thickness by a load of the battery cell.

Hereinafter, a method of manufacturing a battery assembly according to an embodiment of the present disclosure will be described.

A battery assembly manufactured by the method of manufacturing a battery assembly according to an embodiment of the present disclosure may be the same as the battery assembly 1 according to an embodiment of the present disclosure.

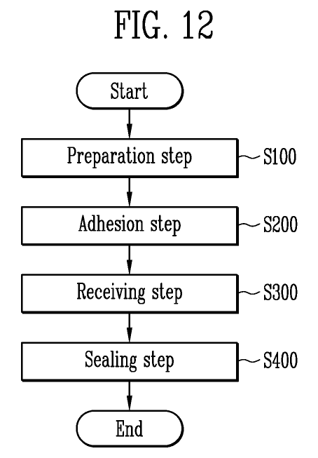

FIG. 12 is a flowchart showing a method of manufacturing a battery assembly according to an embodiment of the present disclosure.

Referring to FIG. 12, the method of manufacturing a battery assembly includes a preparation step S100, an adhesion step S200, a receiving step S300, and a sealing step S400.

First, the preparation step S100 will be described.

The preparation step S100 is a step of preparing a case 100 including a lower plate 110, a side plate 120 connected to the lower plate 110 to form a receiving space S together with the lower plate 110, and an upper plate 130 coupled to the side plate 120 to seal the receiving space S.

Since the specific configuration of the case 100 is the same as the specific configuration of the case 100 of the battery assembly 1 according to an embodiment of the present disclosure described above, a detailed description thereof will be omitted hereinafter.

Next, the adhesion step S200 will be described.

The adhesion step S200 is a step of adhering the plurality of battery cells 200 and the lower plate 110 through the adhesive layer 300 disposed between the plurality of battery cells 200 and the lower plate 110.

Since the specific configurations of the plurality of battery cells 200 and the adhesive layer 300 are the same as the specific configurations of the plurality of battery cells 200 and the adhesive layer 300 of the battery assembly 1 according to an embodiment of the present disclosure described above, a detailed description thereof will be omitted hereinafter.

Next, the receiving step S300 will be described.

The receiving step S300 is a step of accommodating components of the battery assembly 1 in the receiving space S.

In this case, the components of the battery assembly 1 accommodated in the receiving space S in the receiving step S300 may include the busbar assembly 400 and the like.

Meanwhile, since the specific configuration of the busbar assembly 400 is the same as the specific configuration of the busbar assembly 400 of the battery assembly 1 according to an embodiment of the present disclosure described above, a detailed description thereof will be omitted hereinafter.

Next, the sealing step S400 will be described.

The sealing step S400 is a step of coupling the upper plate 130 to the side plate 120 to seal the receiving space S.

The upper plate 130 may be coupled to the side plate 120 by welding or bolt fastening, but the configuration in which the upper plate 130 is coupled to the side plate 120 is not limited thereto.

As such, the method of manufacturing a battery assembly according to the present disclosure provides an effect in that a battery assembly including an adhesive layer capable of being prevented from an increase in parasitic capacitance by including a reinforcement member can be manufactured.

The foregoing description of the present disclosure is for illustrative purposes, and it will be understood by those skilled in the art to which the present disclosure pertains that various modifications can be easily made in other specific forms without changing the technical spirit or essential features of the present disclosure. Therefore, the embodiments described above are to be understood in all respects as illustrative and not restrictive. For example, each component described as being formed in a single body may be implemented in a distributed form, and likewise, components described as being distributed may also be implemented in a combined form.

The scope of the present disclosure is indicated by the claims described below rather than by the foregoing detailed description, and it should be construed that all modifications or altered forms derived from the meaning, scope, and equivalents of the claims fall within the scope of the present disclosure.

What is claimed is:

1. A battery assembly comprising:
a case including a lower plate, a side plate connected to the lower plate to form a receiving space together with the lower plate, and an upper plate coupled to the side plate to seal the receiving space;
a plurality of battery cells coupled to the lower plate and accommodated in the receiving space; and
an adhesive layer disposed between the lower plate and the plurality of battery cells and adhering the lower plate and one surface of each of the plurality of battery cells,
wherein the adhesive layer includes a reinforcement member preventing the adhesive layer from being deformed in shape by a load applied from the plurality of battery cells.

2. The battery assembly according to claim 1, wherein the plurality of battery cells are stacked along a first direction parallel to the lower plate, and
wherein the reinforcement member is formed such that at least a portion thereof is disposed between the one surface of each of the plurality of battery cells and the lower plate.

3. The battery assembly according to claim 2, wherein the reinforcement member includes a first reinforcement portion formed to extend in a longitudinal direction, and
wherein the first reinforcement portion is disposed such that one end thereof is located between the battery cell positioned at one end in the first direction among the plurality of battery cells and the lower plate, and the other end thereof is located between the battery cell positioned at the opposite end in the first direction among the plurality of battery cells and the lower plate.

4. The battery assembly according to claim 3, wherein at least a portion of the first reinforcement portion is disposed to face a first portion of the one surface of each of the plurality of battery cells, and
wherein the first portion is a portion located between one end and the other end in a direction perpendicular to the first direction of the one surface of each of the plurality of battery cells.

5. The battery assembly according to claim 3, wherein the reinforcement member includes a plurality of second reinforcement portions formed to extend in a longitudinal direction, and
wherein some of the plurality of second reinforcement portions are disposed between one end of the one surface of each of the plurality of battery cells in a direction perpendicular to the first direction and the first reinforcement portion, and the remainder are disposed between the other end of the one surface of each of the plurality of battery cells in the direction perpendicular to the first direction and the first reinforcement portion.

6. The battery assembly according to claim 5, wherein some of the plurality of second reinforcement portions are disposed between one end of the one surface of each of the plurality of battery cells in a direction perpendicular to the first direction and the first portion, and the remainder are disposed between the other end of the one surface of each of the plurality of battery cells in the direction perpendicular to the first direction and the first portion.

7. The battery assembly according to claim 1, wherein the adhesive layer includes an adhesive member disposed in a space between the plurality of battery cells and the lower plate, except for a space in which the reinforcement member is disposed.

8. The battery assembly according to claim 7, wherein the reinforcement member is formed of silicone.

9. A method of manufacturing a battery assembly, comprising:
a preparation step of preparing a case including a lower plate, a side plate connected to the lower plate to form a receiving space together with the lower plate, and an upper plate coupled to the side plate to seal the receiving space;
an adhesion step of adhering the plurality of battery cells and the lower plate through an adhesive layer disposed between the plurality of battery cells and the lower plate;
a receiving step of accommodating components of the battery assembly in the receiving space; and
a sealing step of coupling the upper plate to the side plate to seal the receiving space,
wherein the adhesive layer includes a reinforcement member preventing the adhesive layer from being deformed in shape by a load applied from the plurality of battery cells.

10. The method of manufacturing a battery assembly according to claim 9, wherein the reinforcement member is formed such that at least a portion thereof is disposed between the one surface of each of the plurality of battery cells and the lower plate.

11. The method of manufacturing a battery assembly according to claim 10, wherein the plurality of battery cells are stacked along a first direction parallel to the lower plate,
wherein the reinforcement member includes a first reinforcement portion formed to extend in a longitudinal direction, and
wherein the first reinforcement portion is disposed such that one end thereof is located between the battery cell positioned at one end in the first direction among the plurality of battery cells and the lower plate, and the other end thereof is located between the battery cell positioned at the opposite end in the first direction among the plurality of battery cells and the lower plate.

12. The method of manufacturing a battery assembly according to claim 11, wherein at least a portion of the first reinforcement portion is disposed to face a first portion of the one surface of each of the plurality of battery cells, and
wherein the first portion is a portion located between one end and the other end in a direction perpendicular to the first direction of the one surface of each of the plurality of battery cells.

13. The method of manufacturing a battery assembly according to claim 12, wherein the reinforcement member includes a plurality of second reinforcement portions formed to extend in a longitudinal direction, and
wherein some of the plurality of second reinforcement portions are disposed between one end of the one surface of each of the plurality of battery cells in a direction perpendicular to the first direction and the first reinforcement portion, and the remainder are disposed between the other end of the one surface of each of the plurality of battery cells in the direction perpendicular to the first direction and the first reinforcement portion.

14. The method of manufacturing a battery assembly according to claim 13, wherein some of the plurality of second reinforcement portions are disposed between one end of the one surface of each of the plurality of battery cells in a direction perpendicular to the first direction and the first portion, and the remainder are disposed between the other end of the one surface of each of the plurality of battery cells in the direction perpendicular to the first direction and the first portion.

15. The method of manufacturing a battery assembly according to claim 9, wherein the adhesive layer includes an adhesive member disposed in a space between the plurality of battery cells and the lower plate, except for a space in which the reinforcement member is disposed.
